(19) United States
(12) Patent Application Publication
(10) Pub. No.: US 2022/0063135 A1
(43) Pub. Date: Mar. 3, 2022

(54) METHOD AND APPARATUS FOR MANUFACTURING HIGH-HARDNESS DIAMOND SIMULANT BY CUTTING A GEMSTONE INTO 100-SIDED BODY

(71) Applicant: DIA&CO Inc., Seoul (KR)

(72) Inventor: YOUNG DAE KIM, Seoul (KR)

(21) Appl. No.: 17/244,863

(22) Filed: Apr. 29, 2021

(30) Foreign Application Priority Data
Sep. 3, 2020 (KR) 10-2020-0112541
Dec. 29, 2020 (KR) 10-2020-0185551

(51) Int. Cl. B28D 5/00; H04N 5/247; G06K 9/46

(52) U.S. Cl. CPC B28D 5/0064; H04N 5/247; B28D 5/022; B28D 5/0088; G06K 9/4604

(57) ABSTRACT

A technology for processing (and/or working) a gemstone is provided, and specifically, a method for, and an apparatus for manufacturing a high-hardness diamond simulant by cutting a gemstone into a 100-sided body are provided.

### CROSS-REFERENCE TO RELATED APPLICATIONS

This patent application claims priority under 35 U.S.C. § 119 to Korean Patent Application No. 10-2020-0112541 filed on Sep. 3, 2020 and Korean Patent Application No. 10-2020-0185551 filed on Dec. 29, 2020, the entire contents of which are incorporated by reference herein.

### TECHNICAL FIELD

The present disclosure relates to a technology for processing (and/or working) a gemstone. Specifically, the present disclosure relates to a method and an apparatus for manufacturing a high-hardness diamond simulant by cutting a gemstone into a 100-sided body. Further, the present disclosure may be regarded as relating to the fourth industrial technology, since one embodiment of the present disclosure proposes a technology for precision processing a gemstone using various sensors.

### BACKGROUND

Jewel used for accessories and the like including adornments is processed into a size suitable for use as the accessories through a variety of processes including the collection of gemstones.

In this process, the gemstone goes through a complicated process in order to finally become a jewel. In particular, in the process of cutting the gemstone to a certain size, not only the marking of the size at which the gemstone should be cut, but also the cutting of the gemstone after the marking is completed are all manually performed by the operator.

Gemstones (e.g., diamonds) are mechanically processed by several methods such as, for example, cleaving to separate the gemstones, sawing of the gemstones, cutting of the gemstones, and polishing.

All these related methods of processing the surface of the gemstone involve use of a tool such as a disc or a saw blade having the gemstone or gemstone particles fixed thereon, which is pressed against the surface of the target gemstone.

In the related art, when shaping and polishing gemstones, abrasive powders made of unbound type gemstone particles in unbound state are supplied onto a rotating disc/scaif made of cast iron with some oil. The gemstone particles are mechanically processed within the grooves of the cast iron, and as a result, bonded and fixed to the surface of the processed gemstone particles and embedded therein.

Patent documents including EP0354775A, GB2255923A and U.S. Pat. No. 4,484,418A describe a cast iron disc/scaif having diamond particles being bonded and fixed thereon for polishing diamonds in a typical manner.

This typical processing method is very similar to the method of, for example, supplying a rotary disc made of cast iron with abrasive powder with a certain amount of oil and lapping a machine part that is held stationary in the grooves of the cast iron with such abrasive powder.

Apart from the fact that diamond is very difficult to process, the efficiency of known mechanical processing operations varies highly according to the orientation of the diamond crystal structure relative to the processing direction. In some processing operations, certain directions may not be considered, while in other processing operations, it is required that the appropriate processing direction be always determined by experience. This limits and complicates the processing operation and affects the manufacturing time and the required degree of freedom of the machinery and tools used.

When polishing a diamond, the removal rate, which is the rate at which a portion of the diamond to be processed is removed, varies greatly depending on the orientation of the processing direction with respect to the crystal direction. Moreover, it is very difficult to mechanically process the polycrystalline diamond in which crystals are oriented in various directions.

Accordingly, many developers and/or workers in the gemstone processing industry are making efforts to develop an automated system that can easily process gemstone.

In addition, as described above, since the present disclosure also relates to the fourth industrial technology, the following background technology will be described.

The Fourth Industrial Revolution, which is the convergence of digital technology and information and communication technology (ICT), has emerged. The Fourth Industrial Revolution refers to the present and future where innovative technologies such as the Internet of Things (IoT), robotics, virtual reality (VR) and artificial intelligence (AI) will change the way we live and work. While there are developments of computers and information technology (IT) caused by the Third Industrial Revolution as known as the Digital Revolution, it is regarded as a new era rather than the continuation of the Third Industrial Revolution when considering such explosive and destructive nature of the development.

The Fourth Industrial Revolution is characterized by the convergence of technologies such as digital, bio, offline, and the like to generate and collect various information and data, and to classify and analyze collected information and data, and derive the optimal target value (new software) by repetitively learning through this analysis. For technologies relating to the Fourth Industrial Revolution, artificial intelligence (AI) is emerging as the core, and in addition, there are Big data, Internet of Things (IoT), and block chain, and the like. These technologies are applied to various industrial fields such as computers, the Internet, mobile, and robots, either alone or as a fused technology idea, promoting rapid social change and industrial development beyond human imagination.

In many countries around the world, with the Fourth Industrial Revolution, the paradigm that had dominated one era has completely disappeared, and the paradigm that had been in a mutually complementary and competing relationship is taking place as a new paradigm. The Fourth Industrial Revolution is progressing the development of intelligent information technology for various SW fields, such as AI, big data, IoT, blockchain, cloud computing, mobile, and the like beyond the previous information and communication technology (ICT), while paying attention to the value creation method of collecting data from the real world (data acquisition), extracting knowledge by analyzing it in the virtual world (data analysis), and using it in the real world (applying it to reality). In particular, as the center mark of the Fourth Industrial Revolution, AI based on computer software (SW), which combines various technologically advanced technologies with each other, is in the most important position.

The phenomenon of convergence of computers and information and communication technology (ICT) is evident in IoT and blockchain in which all objects and various big data are interconnected and combined (converged) through a network, and also in industrial sites where the boundaries of innovation and companies are collapsing beyond the technological boundaries of IoT and blockchain. The Fourth Industrial Revolution in each country is characterized by the development of computers and information and communication technology (ICT), to create a hyper-connected society in which humans and humans, objects and objects, and humans and objects are interconnected, thereby creating a new technological revolution in which the industrial boundaries disappear. In the era of the Fourth Industrial Revolution, unlike the information-oriented society of the past where communication was enabled with computers, smartphones, SNS, mobile, and the like, a hyper-connected society is formed by building a network that is fused with AI, big data, IoT, blockchain, and the like, and in this hyper-connected society, through the fusion of offline and online, new growth, innovation, and value creation that have not been thought of in the past, such as new business and new products as a value innovation industry, are being achieved.

In the future, billions of people will be connected to mobile devices to collect and store massive amounts of data and information, and the collected data and information will have hyper-connectivity through deep learning technology of artificial neural networks similar to human knowledge such that, with the advancement of AI and big data combination technology, AI and IoT combination technology, and AI and big data and IoT complex combination technology, intelligent and innovative changes are taking place in various fields such as manufacturing, distribution, medical care, education, finance, cinema, and the like. In other words, the convergence and application of technologies relating to the Fourth Industrial Revolution is changing into an intelligent information society that is more innovative and advanced than industrial growth caused by the existing Internet and mobile development.

### SUMMARY

An object of the present disclosure is to provide a method for precision processing a gemstone in various directions.

Another object of the present disclosure is to provide an automated system for automatically processing gemstones.

The technical problems to be achieved in the present disclosure are not limited to the technical problems described above, and other technical problems that are not mentioned herein will be clearly understood by those skilled in the art to which the present disclosure belongs from the following description.

An embodiment of the present disclosure proposes a system for processing gemstones including a gemstone processing apparatus including a holding means for holding a gemstone to be processed based on information indicating a predetermined holding strength, and a processing means for cutting the gemstone to be processed based on information indicating a predetermined cutting strength.

The predetermined holding strength and the predetermined cutting strength may be reset based on image information on the gemstone to be processed, which may be acquired through a sensor module installed in the gemstone processing apparatus.

The system may further include a control module that acquires the image information on the gemstone from the sensor module and resets the predetermined holding strength and the predetermined cutting strength based on the image information on the gemstone to be processed, and the control module may be embedded in the gemstone processing apparatus or may be embedded in a user terminal or a server.

The sensor module may include a plurality of cameras, and the plurality of cameras may be fixed to the gemstone processing apparatus to capture images of the gemstone to be processed from different angles.

The holding means may further include an angle adjusting means for changing an angle or direction for holding the gemstone to be processed.

The processing means may further include a cutting means for cutting the gemstone to be processed, a distance measuring means for measuring a distance between the cutting means and the gemstone to be processed, and a distance adjusting means for changing a position of the cutting means.

As described above, an embodiment of the present disclosure has a technical effect of proposing a method for, and an automated system for precision processing a gemstone in various directions.

In addition, according to an embodiment, a jewel having a plurality of facets may be produced by processing (and/or cutting) the gemstone to be processed in various directions.

Further, since an embodiment of the present disclosure proposes an automated processing system, it is meaningful in that it is possible to produce a processed gemstone that is, a jewel and/or a processed object with a certain quality, regardless of the skill level of an operator.

The effects obtainable in the present disclosure are not limited to the effects described above, and other effects that are not mentioned will be clearly understood by those skilled in the art to which the present disclosure belongs from the following description.

### BRIEF DESCRIPTION OF THE DRAWING

Other aspects, features and benefits, as described above, of certain preferred embodiments of the present disclosure will be more apparent from the following description taken in conjunction with the accompanying drawings, in which:

FIG. 1 illustrates an automatic gemstone processing system according to an embodiment;

FIG. 2 is a flow chart illustrating a gemstone processing method according to an embodiment;

FIG. 3 is a flow chart illustrating a gemstone processing method according to an embodiment;

FIG. 4 is a diagram provided to explain frequency waveforms according to an embodiment;

FIG. 5 illustrates an automatic gemstone processing system according to an embodiment;

FIG. 6 illustrates a part of a gemstone processing apparatus according to an embodiment;

FIG. 7 illustrates a part of a gemstone processing apparatus according to an embodiment;

FIG. 8 illustrates a part of a gemstone processing apparatus according to an embodiment; and

FIG. 9 illustrates a part of a gemstone processing apparatus according to an embodiment.

It should be noted that throughout the drawings, like reference numerals are used to show the same or similar elements, features, and structures.

### DETAILED DESCRIPTION OF THE DISCLOSURE

Hereinafter, embodiments of the present disclosure will be described in detail with reference to the accompanying drawings.

In describing the embodiments, descriptions of technical contents that are well known in the art to which the present disclosure belongs and are not directly related to the present disclosure will be omitted. This is to more clearly convey the gist of the present disclosure by omitting unnecessary description.

For the same reason, some components in the accompanying drawings are exaggerated, omitted, or schematically illustrated. In addition, the sizes of the respective components does not necessarily reflect the actual size. In each drawing, the same reference numerals are assigned to the same or corresponding components.

Advantages and features of the present disclosure and methods of accomplishing the same will be apparent by referring to embodiments described below in detail in connection with the accompanying drawings. However, the present disclosure is not limited to the embodiments disclosed below, and may be implemented in various different forms, and the embodiments are merely provided to make the present disclosure complete, and to fully disclose the scope of the disclosure to those skilled in the art to which the present disclosure belongs, and the disclosure is only defined by the scope of the claims. The same reference numerals refer to the same elements throughout the specification.

In this case, it will be appreciated that each block of the flowchart diagrams and combinations of the flowchart diagrams may be executed by computer program instructions. Since these computer program instructions can be embedded on the processor of a general purpose computer, special purpose computer or other programmable data processing equipment, the instructions, executed by the processor of a computer or other programmable data processing equipment, will generate means for performing the functions described in the flowchart block(s). Since these computer program instructions can also be stored in computer-usable or computer-readable memory that can be directed to a computer or other programmable data processing equipment to implement functions in a particular way, it is also possible for the instructions stored in the computer-usable or computer-readable memory to produce an article of manufacture containing instruction means for performing the functions described in the flowchart block(s). Since the computer program instructions can also be mounted on a computer or other programmable data processing equipment, a series of operational steps can be performed on a computer or other programmable data processing equipment to generate a computer-executable process and the instructions to perform a computer or other programmable data processing equipment can provide steps for executing the functions described in the flowchart block(s).

In addition, each block may represent a module, segment, or part of code that includes one or more executable instructions for executing the specified logical function(s). In addition, it should be noted that, in some alternative execution examples, the functions mentioned in the blocks may occur out of order. For example, two blocks illustrated in succession may in fact be executed substantially simultaneously, or the blocks may sometimes be executed in reverse order according to the corresponding function.

In this case, the term “unit” or “part” used in this embodiment refers to software or hardware components such as field-programmable gate array (FPGA) or application specific integrated circuit (ASIC), and the “unit” or “part” performs certain roles. However, the “unit” or “part” is not meant to be limited to software or hardware. The “unit” or “part” may be configured to be in an addressable storage medium, or may be configured to reproduce one or more processors. Accordingly, as an example, the “unit” or “part” includes components such as software components, object-oriented software components, class components, and task components, processes, functions, attributes, procedures, subroutines, program code segments, drivers, firmware, micro-codes, circuits, data, database, data structures, tables, arrays, and variables. Furthermore, functions provided in the components and the “units” or “parts” may be combined into a smaller number of components and “units” or “parts”, or further divided into additional components and “units” or “parts”. In addition, components and “units” or “parts” may be implemented to re-execute one or more CPUs in a device or a security multimedia card.

In describing the embodiments of the present disclosure in detail, examples of a specific system will be the main object of description, but the main subject to be claimed herein is applicable to other communication systems and services having a similar technical background within the scope not significantly departing from the scope disclosed herein, and this will be possible at the judgment of those skilled in the art.

Hereinafter, a method for, and an automated system for precision processing a gemstone in various directions according to an embodiment will be described.

The present disclosure can be applied to artificial gemstones (or synthetic gemstones) among various gemstones, and among various artificial gemstones (or synthetic gemstones), cubic, that is, cubic zirconia (CZ) will be mainly described, but the features described herein may be equally applicable to other gemstones (or other artificial gemstones or other synthetic gemstones).

Here, the cubic zirconia is a single crystal made by using high-purity ZrO₂ with a high melting point as the main raw material, by melting it uniformly at a high temperature of 3000° C., then forming an initial crystal seed by precise temperature control, and then growing it in the same crystal orientation.

The cubic zirconia is optically and physically very stable and good, and when it is elaborately processed, it looks very beautiful due to the refraction or dispersion features of light, and thus, it is in the spotlight as an artificial diamond for jewelry superior to any other conventional natural diamond imitation products.

In addition, the present disclosure may include a method for manufacturing an artificial gemstone (or synthetic gemstone) by a high frequency induction heating method.

A method for manufacturing cubic zirconia according to an embodiment may include a process of manufacturing cubic zirconia of various colors by adding a rare earth-based element to ZrO₂, which is a main component.

In addition, the method for manufacturing cubic zirconia according to an embodiment may be characterized of manufacturing the cubic zirconia through processes of mixing 75 to 85 parts by weight of ZrO₂, 15 to 20 parts by weight of Y₂O₃, and 0.01 to 2 parts by weight of Co₃O₄, V₂O₅, NiO, or rare earth-based oxides with respect to the total weight of the mixture and filling the mixture into a skull with a heating element installed therein, installing the skull filled with the raw material in a high-frequency induction heating device, and then heating the heating element at a high frequency of 25 to 150 kHz to melt the raw material, and generating seeds of initial crystals while maintaining the obtained melt at a temperature of about 3000° C., growing a single crystal of cubic zirconia by gradually moving an induction coil from a bottom to a top of the skull at a speed of 3.0 to 6.0 mm/hour outside of the high frequency induction heating device, after the growth is completed, cooling inside the skull for 24 to 72 hours, separating the filling material from the skull, and cooling it in the air for 24 to 48 hours and isolating a single crystal part from the separated filling material, and the like.

In addition, according to an embodiment, first, ZrO₂ and Y₂O₃, which are the main components, may be mixed by adding an oxide of Co₃O₄, V₂O₅, NiO, or rare earth-based elements for color development in an amount of 0.01 to 2 parts by weight with respect to the total weight of the mixture. At this time, the main components of ZrO₂ and Y₂O₃ may be used in an amount of 75 to 85 parts by weight and 15 to 20 parts by weight, respectively, with respect to the total weight of the mixture.

In addition, according to an embodiment, the oxide of Co₃O₄, V₂O₅, NiO, or rare earth-based elements may be used in trace amounts to small amounts, that is, 0.01 to 2 parts by weight as a raw material used for color development. According to an embodiment, the oxide of a rare earth-based element may be arbitrarily selected from the group consisting of Er₂O₃, Nd₂O₃, CeO₂, Pr₆O₁₁, and the like, for example, according to the desired color development of cubic zirconia and used.

The raw materials mixed as described above are filled in the skull to which the high frequency induction heating device is attached. In order to efficiently melt the raw material, a heating element for heating by high frequency is installed in the center of the skull, and for such heating element, a graphite ring is preferably used.

When the raw material is completely melted by high frequency, the temperature of the melt is maintained at a high temperature of about 3000° C. to obtain a seed of the initial crystal. When the crystal seed is formed in this way, the induction coil outside the skull is then moved from the bottom to the top of the skull at a speed of 3 to 6 mm per hour to induce from the melt a single crystal growth in the same crystal orientation. In this case, the generated single crystal is grown to a size of 4.0 to 4.8 mm per hour.

The cubic zirconia crystal obtained as described above may exhibit color deviation and desired color effectively.

When the single crystal growth is completed, the skull is detached from the high-frequency induction heating device, cooled inside the skull for 24 to 72 hours, the filling material is separated from the skull, the skull is cooled for 24 to 48 hours in an air atmosphere, and then the single crystal part is isolated.

Since cubic zirconia containing oxides of Co₃O₄, V₂O₅, NiO or rare earth-based elements manufactured according to an embodiment can exhibit various colors such as white, yellow, pink, and the like, it can replace natural jewels such as diamond, amethyst, peridot, and the like.

The artificial gemstone (or synthetic gemstone) manufactured as described above may be processed based on the features described below.

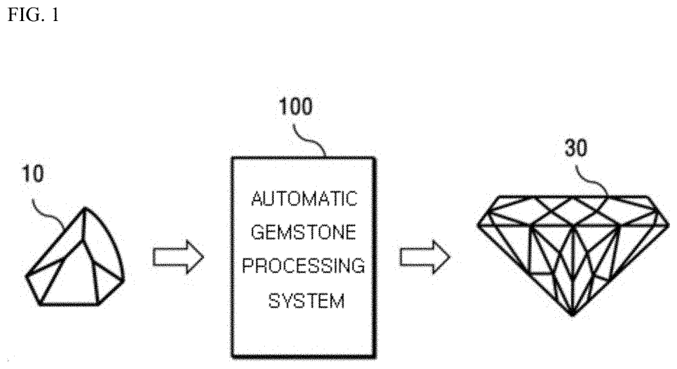

FIG. 1 illustrates an automatic gemstone processing system according to an embodiment.

Referring to FIG. 1, the automatic gemstone processing system 100 according to an embodiment may be provided for producing and/or acquiring a jewel 30 by processing a gemstone 10 to be processed, and the automatic gemstone processing system 100 may include a gemstone processing apparatus 110.

The automatic gemstone processing system 100 according to an embodiment may include a holding means 640 for holding the gemstone 10 to be processed (based on information indicating a predetermined holding strength), and the gemstone processing apparatus 110 including a processing means 630 for cutting the gemstone 10 to be processed (based on information indicating a predetermined cutting strength). The gemstone processing apparatus 110 will be described in detail below.

The gemstone 10 to be processed may refer to a gemstone yet to undergo a working process through the automatic gemstone processing system 100 of the present disclosure, and the jewel 30 may refer to a gemstone, that is, a result (or a processed product) after undergoing the working process by the automatic gemstone processing system 100 of the present disclosure. In addition, the gemstone 10 to be processed may include an ore acquired and/or prepared by the user of the gemstone processing apparatus 110, or an artificial gemstone (or synthetic gemstone) manufactured and/or acquired by the high-frequency induction heating method described above.

In addition, the gemstone 10 to be processed may refer to a stone as a natural stone that is cut out from the production site and that has not been treated on its surface, and may further include diamond, emerald, sapphire, ruby, and the like, for example.

In addition, the gemstone 10 to be processed may further include moissanite (that is, various crystalline polymorphs made of silicon carbide (SiC)), kinite, labradorite, inclusion, labradorite, iolite, and the like.

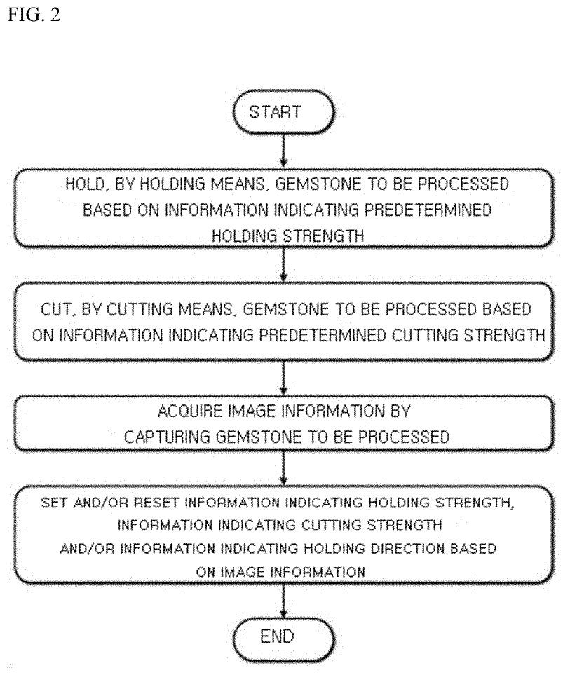

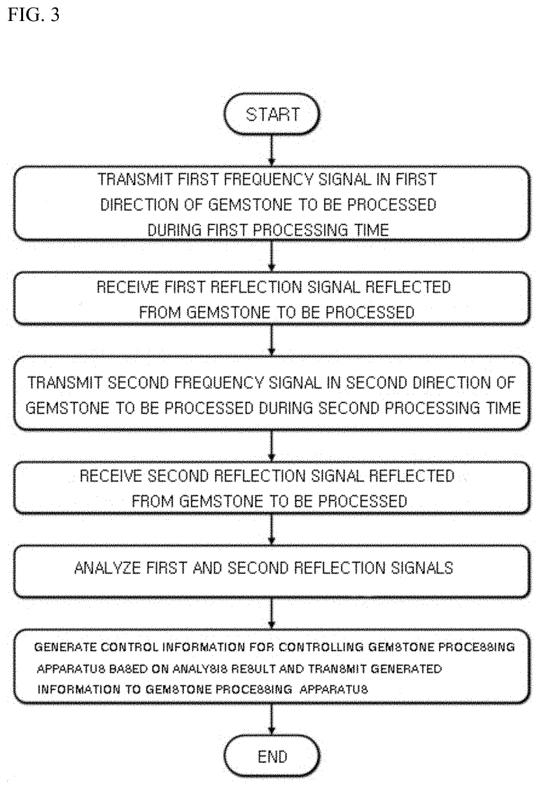

FIGS. 2 and 3 are flowcharts illustrating a gemstone processing method according to an embodiment.

Meanwhile, the gemstone processing method according to FIGS. 2 and 3 may be performed through the process of transmitting and receiving IoT and/or ICT-based signals and/or information between the gemstone processing apparatus 110, a server 120 and/or a terminal 130.

In this example, the IoT may refer to the Internet of Things.

By the Internet of Things (IoT), it may mean the next-generation technology by which all objects in the world are “connected” through a network and communicate with each other. The Fourth Industrial Revolution is to obtain big data through the Internet of Things, store it in the cloud, and analyze and use it with artificial intelligence. The Internet of Things becomes intelligent and can generate a smart world such as smart cars, smart homes, and smart cities.

For example, in a world where the Internet is connected to all fields such as fully autonomous automobiles, smart homes, smart buildings, and healthcare services, the Internet will be like air, and there would be no need to have a separate internet. In order to enable the Internet of Things, there must be more than just the Internet. Various underlying technologies such as sensor and network technology, big data, cloud computing, artificial intelligence, 3D printing, and the like must be harmonized together. In particular, the Fourth Industrial Revolution exhibits the flow of obtaining big data through the Internet of Things, storing it in the cloud, and analyzing and utilizing it with artificial intelligence.

In addition, ICT can refer to the Information and Communication Technology.

Information and Communication Technology (ICT) is a compound word of information technology (IT) and communication technology (CT) and refers to hardware of information devices, software technologies necessary for the operation and information management of these devices, and all methods of collecting, producing, processing, preserving, transmitting, and utilizing information using these technologies. The change of the ICT paradigm can be understood from the perspective of deepening interdependence between each sector in the content (C)-platform (P)-network (N)-device (D) value chain.

In general, the C-PN-T (terminal) value chain has been more widely used to describe the broadcasting platform, but considering the devices such as smartphones and tablets that are actually the computers, the expression C-P-N-D may be more useful in describing ICT. When reviewing the content (C) sector, it is necessary to recall the fact that the classification of photos, books, music, and videos on the Internet is meaningless now. All of these types of contents are digitalized and provided to users by platform providers, and content holders provide the contents by partnering with platform providers such as Google, Apple, and Amazon, or by configuring their own platforms. The platform sector can play an important role in the C-P-N-D value chain.

The contents on the Internet can be accumulated, processed, stored, and provided by software. This means that ICT companies with software technology will take the initiative. In particular, cloud service providers with software technology and cloud infrastructure are emerging as representative platform providers. In the process, there is a possibility that the status of traditional network transport service providers will be relatively weakened. On the other hand, companies with source contents will be able to establish an equal relationship with the platform provider. The network in the era of digital convergence is the IP network, that is, the Internet. The traditional networks such as circuit-type telephone networks provide intelligent services such as user identification by network holders themselves, but in the case of the Internet, various service providers such as Akamai provide various network functions such as efficient traffic transmission, security, and the like through server clusters in competitive markets.

In the sense that such an intelligent network service provider is also a kind of platform provider, it is indeed difficult to distinguish between a platform and a network. It is also important that operators with communication networks directly provide platform services. The device division is always connected to the Internet, and a software program inside the device with a general-purpose operating system such as iOS is connected to the platform to complete the service. It can be said that Apple is a representative example where the platform provider is the device provider at the same time, and when considering the alliance between Google and Android phone makers, it can be seen that the relationship between the platform division and the device division is closer and interdependent than that in the past. The alliance between the content division and the platform division, the connection between the device division and the platform, and the blurring of the boundaries between the platform division and the network division may all mean deepening interdependence in each division of C-P-N-D.

For example, the server 120 may be implemented using a web server program provided variously according to operating systems such as DOS, Windows, Linux, Unix, Macintosh, and the like in general server hardware.

For example, the terminal 130 may include a smartphone, a mobile phone, a smart TV, a set-top box, a tablet PC, a digital camera, a camcorder, and an e-book terminal, a digital broadcasting terminal, personal digital assistant (PDA), a portable multimedia player (PMP), a navigation, an DVD player, a wearable device, an air conditioner, a microwave oven, an audio, a DVD player, and the like. In this example, the personal computer may include a laptop computer, a desktop, and the like.

Referring to FIG. 2, a gemstone processing method according to an embodiment may include holding, by the holding means, the gemstone to be processed based on the information indicating a predetermined holding strength, at S210.

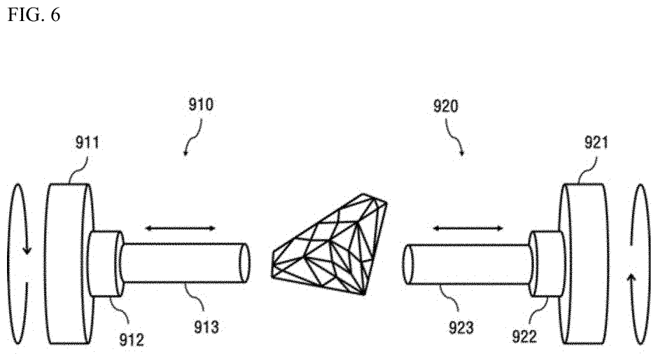

For example, the gemstone 10 to be processed may be held or positioned at a specific position (and/or at an angle, a height, and the like) using a first holding part 910 and/or a second holding part 920 illustrated in FIGS. 6, 8 and 9. That is, the holding means 640 may include the first holding part 910 and/or the second holding part 920.

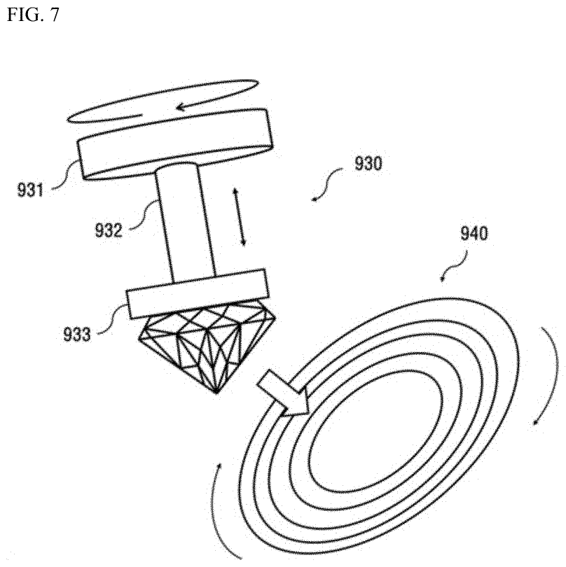

For example, the gemstone 10 to be processed may be held or positioned at a specific position (and/or at an angle, a height, and the like) using a third holding part 930 illustrated in FIG. 7. That is, the holding means 640 may include the third holding part 930.

In addition, the predetermined holding strength may be set and/or controlled by a control module 610 of the gemstone processing apparatus 110 and/or a control module 710 of the server 120, and the information indicating the predetermined holding strength may be transmitted from the control modules 610 and 710 to the holding means 640 of the gemstone processing apparatus 110.

For example, the control modules 610 and 710 may arbitrarily set the predetermined holding strength as a first holding strength.

In addition, the gemstone processing method according to an embodiment may include cutting the gemstone to be processed based on the information indicating a predetermined cutting strength by the processing means, at S220.

For example, the gemstone 10 to be processed may be processed and/or cut using a metal saw 940 illustrated in FIG. 7. That is, the processing means 630 may include the metal saw 940.

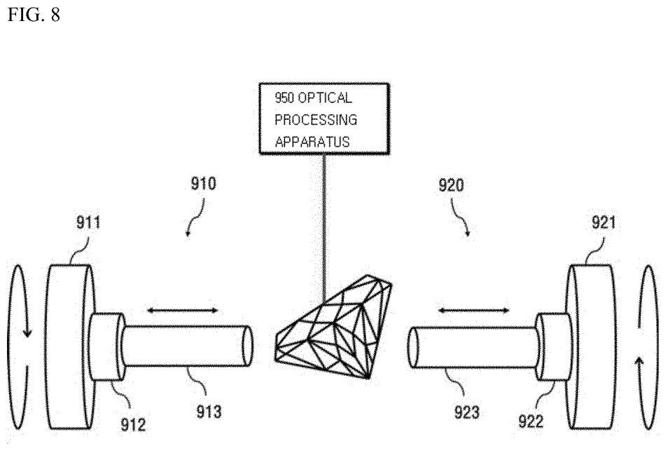

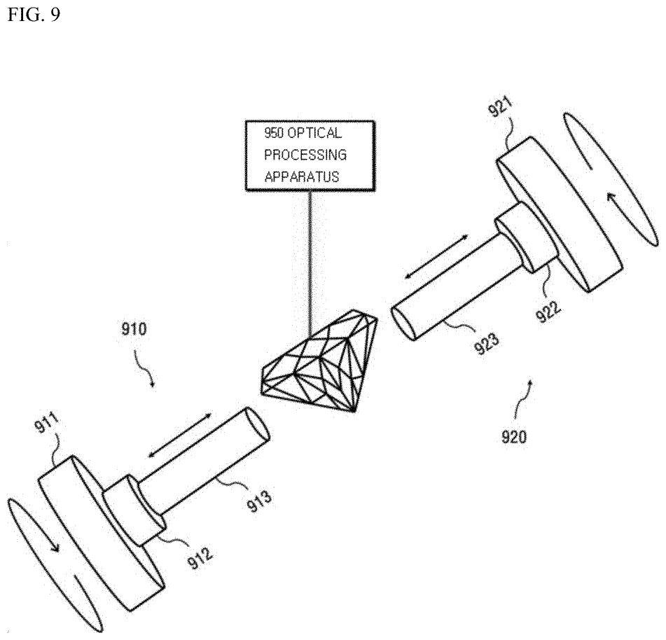

For example, the gemstone 10 to be processed may be processed and/or cut using an optical processing apparatus 950 illustrated in FIGS. 8 and 9. That is, the processing means 630 may include the optical processing apparatus 950.

In addition, the predetermined cutting strength may be set and/or controlled by the control module 610 of the gemstone processing apparatus 110 and/or the control module 710 of the server 120, and the information indicating the predetermined cutting strength may be transmitted from the control modules 610 and 710 to the processing means 630 of the gemstone processing apparatus 110.

For example, the control modules 610 and 710 may arbitrarily set the predetermined cutting strength as a first cutting strength.

In addition, the gemstone processing method according to an embodiment may include acquiring image information by capturing images of the gemstone to be processed, at S230.

The gemstone processing apparatus 110 may include a sensor module 650 including a plurality of cameras, and may be configured to capture images of the gemstone 10 to be processed using at least any one of the plurality of cameras to acquire image information on the gemstone 10 to be processed.

The gemstone processing apparatus 110 and/or the server 120 applies various algorithms for extracting object features such as Histogram of Oriented Gradient (HOG), Haar-like feature, co-occurrence HOG, local binary pattern (LBP), features from accelerated segment test (FAST), and the like to the image information, thereby obtaining the image information and/or the outline of the object in the image or the text (or the outline (or appearance) representing information) that can be extracted from the object from the image information and/or the image obtained through the sensor module 650.

Through this process, the gemstone processing apparatus 110 and/or the server 120 may generate and/or acquire object information on the gemstone 10 to be processed, and the object information on the gemstone 10 to be processed may include information (e.g., number of planes (e.g., 100-sided body, 100-sided cut)) on a plurality of planes generated and/or formed on the gemstone 10 to be processed.

In addition, the gemstone processing method according to an embodiment may include setting and/or resetting the information indicating a holding strength, the information indicating a cutting strength, and/or information indicating a holding direction based on the image information, S240.

For example, the gemstone processing apparatus 110 and/or the server 120 may differently set the processing mode of the gemstone processing apparatus 10, control information about the processing means 630 and/or the holding means 640, and the like based on whether or not the information (e.g., the number of planes) on a plurality of planes generated and/or formed on the gemstone 10 to be processed satisfies a predetermined criterion.

For example, the gemstone processing apparatus 110 and/or the server 120 may generate and/or set specific instructions for changing the processing mode, and for the processing means 630 and/or the holding means 640 of the gemstone processing apparatus 10, when the number of a plurality of planes generated and/or formed on the gemstone 10 to be processed (or the number of planes identified in the gemstone 10 to be processed) exceeds a threshold value.

For example, the gemstone processing apparatus 110 and/or the server 120 may set the gemstone processing apparatus 10 to the first processing mode, when the number of a plurality of planes generated and/or formed on the gemstone 10 to be processed (or the number of planes identified in the gemstone 10 to be processed) is less than a first threshold value, may set the gemstone processing apparatus 10 to a second processing mode, when the number is less than a second threshold value and is equal to or greater than the first threshold value, and may set the gemstone processing apparatus 10 to a third processing mode when the number is equal to or greater than the second threshold value.

When the gemstone processing apparatus 10 is set to the first processing mode, the holding strength of the holding means 640 is set to a first holding strength, and the cutting strength of the processing means 630 may be set to a first cutting strength.

When the gemstone processing apparatus 10 is set to the second processing mode, the holding strength of the holding means 640 is set to a second holding strength, and the cutting strength of the processing means 630 may be set to a second cutting strength. For example, the second holding strength may refer to a strength greater than the first holding strength. As another example, the second fixed strength may refer to a suction force having a greater value than the first fixed strength. In addition, the second cutting strength may correspond to an angular velocity (or rotational force) greater than the first cutting strength.

When the gemstone processing apparatus 10 is set to the third processing mode, the holding strength of the holding means 640 may be set to a third holding strength, and the cutting strength of the processing means 630 may be set to a third cutting strength. For example, the third holding strength may refer to a strength greater than the first holding strength and the second holding strength. As another example, the third holding strength may refer to a suction force having a greater value than the first holding strength and the second holding strength. In addition, the third cutting strength may correspond to an angular velocity (or rotational force) greater than the first cutting strength and the second cutting strength.

Meanwhile, the first cutting strength, the second cutting strength, and/or the third cutting strength described above may refer to a rotational intensity, a rotational angular velocity (rad/s), and the like of the metal saw 940 to be described below, and/or may refer to a light emission intensity (Watt, Joule, Fluence, and the like), a light emission heat temperature (e.g., X° C.), a light emission frequency (Hz), a light emission period, and the like of the optical processing apparatus 950.

The first holding strength, the second holding strength, and/or the third holding strength may refer to a suction power (Air Watt (AW), Pascal (pa)), which is an intensity by which a vacuum suction means to be described below sucks the gemstone 10 to be processed.

In addition, the gemstone processing method according to an embodiment may further include the following features.

The gemstone processing method according to an embodiment may include selecting a gemstone of a color and size to be processed into a jewel from among a plurality of gemstones and cutting the selected gemstone to a specific size using a metal saw corresponding to, or included in the processing means 630.

In addition, in order to hold the gemstone cut of the specific size to a stick having a groove of a specific shape (e.g., V-shape) formed at its tip, the method may include cutting and focusing toward the center of the back side of the cut gemstone, then melting the gemstone focused on the back side of the gemstone while heating a predetermined adhesive (e.g., Jewelry adhesives, modeling adhesives, Copal Gum and Shellac Gum, and the like) to a temperature in a specific temperature range (e.g., 400° C. to 1000° C.) with an alcohol lamp, and then holding the result in the holding means 640 (e.g., a stick (a member that melts and/or adheres a predetermined adhesive to the gemstone to facilitate polishing of the gemstone)).

Then, the method secures the gemstone (the gemstone cut of the specific size) held in the holding means 640 in an index and processing the same with the correct dimensions while rotating the disc having diamond electrodeposited thereon, and then cutting the gemstone, which was held in the holding means 640 and processed to the correct dimensions, while spraying water to form a number of angles to the upper plane, left and right edges, front and rear edges of the gemstone on a double-ended polisher (and/or double-ended cutter), and then polishing the surface of the gemstone now having a number of angles formed at the top plane, left and right edges, and the front and rear edges, while rotating the polishing disc having diamond powder (and/or mineral) applied thereon such that the surface of the gemstone shines.

As described above, the method may include applying heat to the surface of the gemstone having a plurality of angles on the top, left and right edges, and the front and rear edges with the alcohol lamp to melt the predetermined adhesive and thus detach the processed gemstone attached to the holding means 640, and removing the predetermined adhesive attached to the rear surface by putting the processed gemstone detached from the holding means 640 in alcohol or caustic soda (lye).

The polishing disc used in the polishing process is a circular plate made of an alloy of tin and silver, and having a fine groove formed on the upper plane toward the center to allow the polishing agent (and/or polishing agent) to be attached, in which the polishing agent may preferably include a known agent including synthetic diamond powder, polishing compound, chromium oxide, and the like, and preferably have a particle size of 50 to 200,000 mesh.

In addition, for the predetermined adhesive, it may be desirable to use a known synthetic resin adhesive that melts at a temperature in a specific temperature range (e.g., 400° C. to 1000° C.).

As described above, since the gemstone is processed into jewels, when the gemstone is processed by the gemstone processing method of the present disclosure, cracks in the gemstone can be reduced during cutting and polishing of the gemstone, so that the production yield is improved, and also it is possible to inexpensively and easily process the gemstone (e.g., artificial gemstones and/or synthetic gemstones) into a jewel.

Referring to FIG. 3, the gemstone processing method according to an embodiment may include transmitting a first frequency signal in a first direction of the gemstone to be processed during a first processing time, at S310.

For example, the gemstone processing apparatus 110 may include a sensor module 620 including at least one microwave sensor, and a means (and/or device) for changing the position and direction of the at least one microwave sensor.

In addition, for example, the gemstone processing apparatus 110 and/or the server 120 may control the first microwave sensor installed in the first position such that the first frequency signal is transmitted to the gemstone 10 to be processed in the first direction.

The gemstone processing method according to an embodiment may include receiving a first reflection signal reflected from the gemstone to be processed, at S320.

For example, the gemstone processing apparatus 110 may include the sensor module 620 including at least one microwave sensor, and the at least one microwave sensor may receive the first reflection signal and transmit information on the received first reflection signal to the gemstone processing apparatus 110 and/or the server 120.

The gemstone processing method according to an embodiment may include transmitting a second frequency signal in a second direction of the gemstone to be processed during a second processing time, at S330.

For example, the gemstone processing apparatus 110 may include a sensor module 620 including at least one microwave sensor, and a means (and/or device) for changing the position and direction of the at least one microwave sensor.

In addition, for example, the gemstone processing apparatus 110 and/or the server 120 may control the second microwave sensor installed in the second position such that the second frequency signal is transmitted to the gemstone 10 to be processed in the second direction.

Meanwhile, the first direction and the second direction may be set differently from each other, and the second processing time may be set differently from the first processing time.

The gemstone processing method according to an embodiment may include receiving a second reflection signal reflected from the gemstone to be processed, at S340.

For example, the gemstone processing apparatus 110 may include the sensor module 620 including at least one microwave sensor, and the at least one microwave sensor may receive the second reflection signal and transmit information on the received second reflection signal to the gemstone processing apparatus 110 and/or the server 120.

The gemstone processing method according to an embodiment may include analyzing the first and second reflection signals, at S350.

The gemstone processing method according to an embodiment may include generating control information for controlling the gemstone processing apparatus based on the analysis result and transmitting the generated information to the gemstone processing apparatus, at S360.

In this example, the control information may be information about the first holding strength, the second holding strength, the third holding strength, the first cutting strength, the second cutting strength, and the third cutting strength.

For example, the control information may include, for example, instructions for controlling an electric motor or a cylinder to increase the length of a holding frame 913, 923, and 933 to increase the first to third holding strengths, information on the length of a holding part 910, 920, and 930 reset to a longer length, and the like. In addition, the control information may include instructions for increasing the suction force of the vacuum suction means to increase the holding strength, for example, instructions for further increasing the output of the electric motor for the above purpose, information indicating a suction force that is reset to a greater degree, and the like.

The control information may include instructions for setting the rotational speed of rotating parts 911, 912, 921, 922 to a higher degree to increase the first to third cutting strengths, for example, information for further increasing the output of the electric motor for the above purpose, and the like.

The control information may include information indicating a rotational strength of the metal saw 940 and a rotational angular velocity (rad/s) to increase the first to third cutting strengths, for example, and information including the light emission intensity (Watt, Joule, Fluence, and the like), the light emission heat temperature (e.g., X ° C.), the light emission frequency (Hz), the light emission period (period) of the optical processing apparatus 950, which are set to higher degrees.

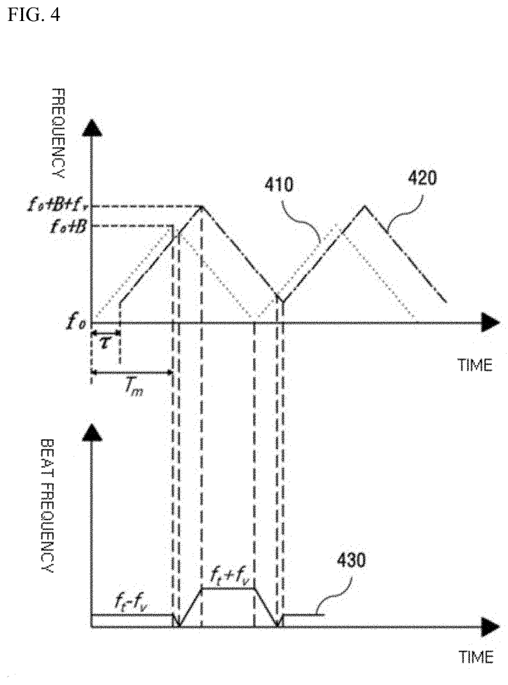

FIG. 4 is a diagram provided to explain frequency waveforms according to an embodiment.

In addition, FIG. 4 may be related to the first frequency signal, the first reflection signal, the second frequency signal, and the second reflection signal described in S310 to S340.

The sensor module 620 according to an embodiment may include a microwave sensor, and may recognize the position (and/or distance) of the gemstone 10 to be processed based on a microwave signal transmitted through the object.

In addition, the microwave sensor may be installed and/or embedded in the gemstone processing apparatus 110, and for example, the microwave sensor may be installed in the processing means 630 or in the holding means 640. The microwave sensor may recognize that the gemstone to be processed approaches (or moved away) through transmission (and/or radiation) of a frequency signal and acquisition of a reflected signal. In addition, the microwave sensor may perform: a first step of continuously transmitting a transmission signal 410 generated from the microwave sensor; a second step of receiving a reception signal 420, which is the transmission signal 410 reflected off from an object for sensing, that is, from the gemstone to be processed and then input to the microwave sensor; a third step of generating a frequency waveform 430 of the object for sensing, by mixing the transmission signal 410 and the reception signal 420; and a fourth step of storing the frequency waveform 430 in a storage module (e.g., memory) of the gemstone processing apparatus 110. The “reception signal 420” as used herein may also be referred to as a “reflection signal”.

In addition, the microwave sensor may also include: a fifth step of repeatedly performing the first to fourth steps described above and constructing a database of the object for sensing by classifying a plurality of frequency waveforms 430 stored in the storage module of the gemstone processing apparatus 110 according to whether the object for sensing is the gemstone to be processed or other object; and a sixth step (S60) of identifying whether the object for sensing is the gemstone 10 to be processed or other object, by comparing the frequency waveform 430 generated by performing the first to third steps with the frequency waveform 430 stored in the database described above, when the object for sensing approaches the microwave sensor.

For example, the use frequency of the transmission signal 410 and the reception signal 420 is about 10.525 GHz, and the acquired signal may output a frequency shift over continuous time as a graph through Frequency Modulated Continuous Wave (FMCW) modulation as the graph shown at the top of FIG. 4.

In this case, a time taken between when the transmission signal 410 is transmitted from the microwave sensor and when the reception signal 420 reflected off from the object for sensing is input to the microwave sensor may be expressed as t=2 R/c. Here, R is the distance between the microwave sensor and the object for sensing, and c is the speed of light, which is about 3*108 [m/s].

In addition, with this, when mixing the transmission signal 410 and the reception signal 420 in the third step described above, the distance (R) and speed (vr) information with respect to the object for sensing is generated through the sum and difference of the frequency shift (ft) caused by the time delay and the frequency shift (fv) caused by the Doppler effect, and the frequency waveform 430 in which the transmission signal 410 and the reception signal 420 are mixed is generated, as the graph illustrated at the bottom of FIG. 4.

In addition, τ of FIG. 4 is a round trip delay, and it is a time taken for the received signal 420, which is the transmission signal 410 transmitted from the microwave sensor and reflected off from the object for sensing, to be input to the microwave sensor, and in the graph illustrated at the top of FIG. 4, Tm is a frequency shift unit time (sweep time), and is a time taken for the frequency of the transmission signal 410 or the reception signal 420 to increase from f0, which is a minimum frequency, to a peak level.

In addition, in the graph illustrated at the bottom of FIG. 4, ft is the frequency shift caused by the time delay, and fv is a frequency shift caused by the Doppler effect.

In addition, when mixing the transmission signal 410 and the reception signal 420 in the third step, the distance (R) and approaching speed (Vr) information with respect to the object for sensing are generated through the sum and difference of the frequency shift (ft) caused by the time delay and the frequency shift (fv) caused by the Doppler effect.

In addition, the distance R of the object for sensing may be

$$R = \frac{{f}_{t} * c * {T}_{m}}{n * B} ,$$

and the approaching speed Vr of the object for sensing may be

$${V}_{r} = \frac{{f}_{v} * λ}{n} .$$

Here, B may be the frequency shift bandwidth (sweep bandwidth), Tm may be the frequency shift unit time (sweep time), ft may be the frequency shift caused by the time delay, fv may be a frequency shift caused by the Doppler effect, c may be a light flux (3*108 mm/s), and λ may be a frequency wavelength. In this case, n may be an integer, and n may be 2, for example.

The third step may include, when the frequency shift value fv caused by the Doppler effect converges in the range of 60 to 150 Hz, classifying it to be the gemstone to be processed and storing the information, and the fourth step may include, when acquiring the distance (R) and the approach speed (Vr) information with respect to the object for sensing, limiting the approach speed (Vr) to a specific speed range (e.g., 0.1 to 1 km/h, 1 to 10 km/h) as the approach speed with respect to the gemstone 10 to be processed, whereby the Doppler frequency fV measured outside the 0-200 Hz range may be treated as noise. As described above, the Doppler frequency shift value of the gemstone 10 to be processed may exclude the information that can be classified as a person through the actual measured value, thereby improving accuracy, and thus improving the false recognition rate.

In addition, in the fourth step described above, the amplitude, duration, peak level, polarity, rise time of each of the transmission signal 410 and the reception signal 420 according to the distance of the object for sensing are stored together with the frequency waveform 430, and in the fifth step, along with the frequency waveform 430, the object for sensing is classified according to whether it is the gemstone 10 to be processed or other object, and stored in the database, and in the sixth step, when the object for sensing approaches, the first to third steps are performed, and the amplitude, the duration, the peak level, the polarity, the rise time, and the frequency waveform 430 of the transmission signal 410 and the reception signal 420 according to the distance of the object for sensing are compared with each classified data in the database to identify whether the object for sensing is the gemstone 10 to be processed or other object.

In the sixth step described above, when the frequency band is output, when the peak-to-peak value of each amplitude is 142 at 11 Hz, 77.9 at 18 Hz, 65.5 at 26 Hz, and 74.6 at 29 Hz, it can be classified and stored as human reference pattern information.

The data of the amplitude, the duration, the peak level, the polarity, the rise time, and the frequency waveform 430 described above, each being classified in the database, may be generated as a sequence of unique signal waveforms that can classify the motion of the object for sensing according to whether it is the gemstone 10 to be processed or other object, and big data can be constructed through this.

In addition, the gemstone processing apparatus 110 and/or the control module 120 may differently set the control information and the like about the processing mode, the processing means 630, and/or the holding means 640 of the gemstone processing apparatus 10, based on the reflected signal 420, the frequency waveform 430 acquired through the microwave sensor, and/or the information indicating whether the object for sensing is the gemstone 10 to be processed or other object.

In addition, for example, the gemstone processing apparatus 110 and/or the server 120 may select a processing mode of the gemstone processing apparatus 110 to be one of a first to a third processing modes, or determine whether or not to operate the processing means 630 (ON), based on whether the information (e.g., the number of planes (e.g., 100-sided body, 100-sided cut)) on the plurality of planes identified in the processing target gemstone 10 satisfies a predetermined criterion (that is, when the number of planes exceeds the threshold value), and also based on whether or not it is determined that the reflected signal 420, the frequency waveform 430 and/or the object for sensing acquired through the microwave sensor is the gemstone 10 to be processed.

In addition, the method according to an embodiment may further include the following features.

A method according to an embodiment may include acquiring an artificial gemstone (or synthetic gemstone) by the high-frequency induction heating method described above, removing impurities such as air bubbles and sludge, molding the artificial gemstone removed of the impurities into various types of molds, firing the molded mixture completed with the molding step in a firing chamber and cooling after the heat treatment, and processing a surface of the molded mixture completed with the firing.

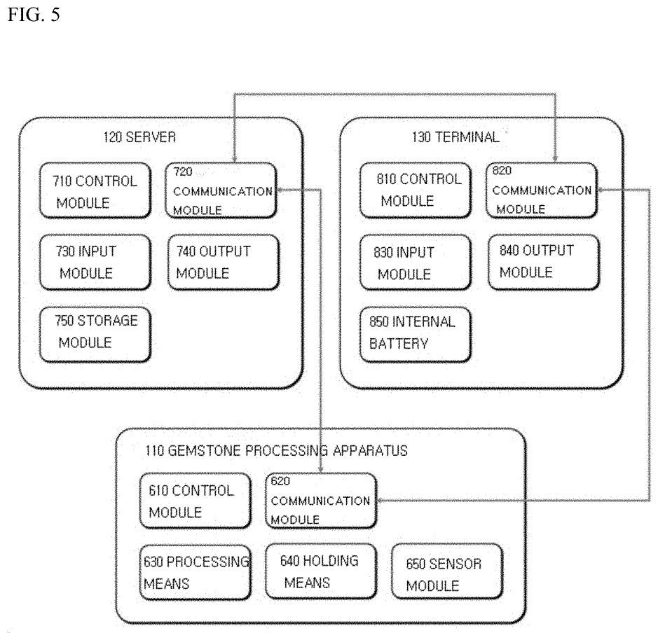

FIG. 5 illustrates an automatic gemstone processing system according to an embodiment.

Referring to FIG. 5, the gemstone processing apparatus 110 may include the control module 610, the communication module 620, the processing means 630, the holding means 640, and the sensor module 650. In addition, the server 120 may include the control module 710, a communication module 720, an input module 730, an output module 740, and a storage module 750, and the terminal 120 may include a control module 810, a communication module 820, an input module 830, an output module 840, and an internal battery 850.

The control modules 610, 710, and 810 may directly or indirectly control the gemstone processing apparatus 110, the server 120 and/or the terminal 130 to implement the operations, steps, and processes according to an embodiment. In addition, the control modules 610, 710, and 810 may include at least one processor, and the processor may include at least one central processing unit (CPU) and/or at least one graphic processing unit (GPU).

In addition, the control modules 610, 710, and 810 may control the overall operation of the server 120. For example, the control modules 610, 710, and 810 may control the database, the transmission/reception unit, and the like as a whole by executing programs stored in the database of the server 120. For example, the control modules 610, 710, and 810 may perform some of the operations of the server 110 described with reference to FIGS. 1 to 9 by executing programs stored in the database of the server 120.

In addition, the control modules 610, 710, and 810 may generate and/or manage control information (e.g., instructions) and the like, based on Application Programming Interface (API), Internet of Things (IoT), Industrial Internet of Things (IIoT), and Information & Communication Technology (ICT).

The communication modules 620, 720, and 820 may transmit and receive various data, signals, and information to and from the gemstone processing apparatus 110, the server 120, and/or the terminal 130. Further, the communication modules 620, 720, and 820 may include a wireless communication module (e.g., a cellular communication module, a short-range wireless communication module, or a global navigation satellite system (GNSS) communication module) or a wired communication module (e.g., a local area network (LAN) communication module, or a power line communication module). In addition, the communication modules 620, 720, and 820 may communicate with an external electronic device through a first network (e.g., Bluetooth, WiFi direct, or a short-range communication network such as Infrared Data Association (IrDA)) or a second network (e.g., a cellular network, the Internet, or a telecommunication network such as a computer network (e.g., LAN or WAN)). These various types of communication modules may be integrated into one component (e.g., a single chip), or may be implemented with a plurality of components (e.g., multiple chips) that are separate from each other.

The input modules 730 and 830 may receive commands or data to be used in the components of the gemstone processing apparatus 110, the server 120, and/or the terminal 130 (e.g., control modules 610, 710, 810, and the like) from the gemstone processing apparatus 110, the server 120, and/or the outside of the terminal 130 (e.g., a user (e.g., a first user, a second user, and the like), an administrator of the server 120, and the like). In addition, the input modules 730 and 830 may include a touch-recognizable display, a touch pad, a button-type recognition module, a voice recognition sensor, a microphone, a mouse, a keyboard, and the like, which may be installed in the gemstone processing apparatus 110, the server 120 and/or the terminal 130. In addition, the touch-recognizable display, the touch pad, and the button-type recognition module may recognize a touch by a user's body (e.g., a finger) through a resistive method and/or a capacitive method.

The output modules 740 and 840 are modules that display signals (e.g., audio signals), information, data, images, and/or various objects, and the like that are generated by the control modules 610, 710, and 810 of the gemstone processing apparatus 110, the server 120, and/or the terminal 130 or acquired through the communication modules 620, 720 and 820. For example, the output modules 740 and 840 may include a display, a screen, a display unit, a speaker, and/or a light emitting device (e.g., an LED lamp), and the like.

The storage module 750 stores data such as a basic program, an application program, and setting information for the operation of the gemstone processing apparatus 110, the server 120 and/or the terminal 130. In addition, the storage module may include at least one storage medium of a flash memory type, a hard disc type, a multimedia card micro type, a card type memory (e.g., SD or XD memory, and the like), a magnetic memory, a magnetic disc, an optical disc, Random Access Memory (RAM), Static Random Access Memory (SRAM), Read-Only Memory (ROM), Programmable Read-Only Memory (PROM), and Electrically Erasable Programmable Read Only Memory (EEPROM).

In addition, the storage module 750 may store personal information of a customer (first user) who uses the gemstone processing apparatus 110, the server 120 and/or the terminal 130, and the personal information of an administrator (second user), and the like. Here, the personal information may include a name, an identifier (ID), a password, a street name address, a phone number, a mobile phone number, an email address, and/or information indicating a reward (e.g., points, and the like) generated by the server 120, and the like. In addition, the control modules 610, 710, and 810 may perform various operations using various images, programs, contents, data, and the like stored in the storage module 750.

FIGS. 6 to 9 are diagrams illustrating a part of a gemstone processing apparatus according to an embodiment.

Referring to FIG. 6, the holding means 640 according to an embodiment may include a first holding part 910 and a second holding part 920. The first holding part 910 may include a first rotating part 911, a second rotating part 912, and a first holding frame 913, and the second holding part 920 may include a third rotating part 921 and a fourth rotating part 922, and a second holding frame 923.

The first holding part 910 and/or the second holding part 920 may include a chucking means, a vacuum suction means, a magnet member, and the like. For example, when the gemstone 10 to be processed can not be held by the magnetic member, the vacuum suction means may suck the gemstone 10 to be processed to hold it to one side of the first holding part 910 and/or the second holding part 920 or to the first holding frame 913 and/or the second holding frame 923. Meanwhile, the vacuum suction means may include a suction port (not illustrated) to securely hold the gemstone 10 to be processed by suctioning air, and an electric motor (not illustrated) to generate a predetermined suction force.

In addition, the first holding part 910 and/or the second holding part 920 may include an electric motor and/or a cylinder for extending the first holding frame 913 and/or the second holding frame 923.

For example, the second rotating part 912 and/or the fourth rotating part 922 may include cylinders, and the first holding frame 913 and/or the second holding frame 923 may include cylinder rods.

Each of the first rotating part 911, the second rotating part 912, the third rotating part 921, and the fourth rotating part 922 may include an electric motor for rotating each of the first rotating part 911, the second rotating part 912, the third rotating part 921, and the fourth rotating part 922.

Referring to FIG. 7, the holding means 640 according to an embodiment may include the third holding part 930, and the third holding part 930 may include the fifth rotating part 911, a column member 932, and the third holding frame 933. In addition, the processing means 630 according to an embodiment may include the metal saw 940.

In addition, referring to FIGS. 8 and 9, the processing means 630 according to an embodiment may include the optical processing apparatus 950, and may include a laser cutting device including a function of emitting a laser for working a plane of the gemstone 10 to be processed.

The optical processing apparatus 950 may include a laser cutting head, a head bracket, a laser oscillator, a gas utility, and the like. The laser beam is generated by the laser oscillator and transmitted using an optical fiber, and transmitted through the laser cutting head to a plane of an object for cutting, that is, of the gemstone 10 to be processed.

Additionally, an oxygen cutting device (not illustrated) including an oxygen cutting torch instead of the optical processing apparatus 950 may be further included in the automatic gemstone processing system 100, and oxygen cutting may basically include three lines, and may include a line that transmits high-pressure oxygen, preheating gas, and propane or acetylene gas. Using such a gas, the object for cutting may be cut with oxygen.

The third holding part 930 may include a chucking means, a vacuum suction means, a magnet member, and the like. For example, when the gemstone 10 to be processed can not be held by the magnetic member, the vacuum suction means may suck the gemstone 10 to be processed to hold it to one side of the third holding part 930 and/or the third holding frame 933.

In addition, the third holding part 930 may include an electric motor and/or a cylinder for extending the third holding frame 933.

For example, the fifth rotating part 911 may include a cylinder, and the third holding frame 933 may include a cylinder rod.

The fifth rotating part 911 may include an electric motor for rotating the fifth rotating part 911.

In addition, the sensor module 650 may include a plurality of cameras, and may capture images of the gemstone 10 to be processed to acquire image information.

The gemstone processing apparatus 110 and/or the server 120 applies various algorithms for extracting object features such as Histogram of Oriented Gradient (HOG), Haar-like feature, co-occurrence HOG, local binary pattern (LBP), features from accelerated segment test (FAST), and the like to the image information, thereby obtaining the image information and/or the outline of the object in the image or the text (or the outline (or appearance) representing information) that can be extracted from the object from the image information and/or the image obtained through the sensor module 650.

Through this process, the gemstone processing apparatus 110 and/or the server 120 may generate and/or acquire object information on the gemstone 10 to be processed, and the object information on the gemstone 10 to be processed may include information (e.g., number of planes (e.g., 100-sided body, 100-sided cut)) on a plurality of planes generated and/or formed on the gemstone 10 to be processed.

In addition, the gemstone processing apparatus 110 and/or the server 120 may differently set the processing mode of the gemstone processing apparatus 10, control information about the processing means 630 and/or the holding means 640, and the like based on whether or not the information on a plurality of planes generated and/or formed on the gemstone 10 to be processed (e.g., the number of planes) satisfies a predetermined criterion.

For example, the gemstone processing apparatus 110 and/or the server 120 may generate and/or set specific instructions for changing the processing mode, and for the processing means 630 and/or the holding means 640 of the gemstone processing apparatus 10, when the number of a plurality of planes generated and/or formed on the gemstone 10 to be processed exceeds a threshold value.

The embodiments of the present disclosure disclosed in the present specification and drawings are merely presented as specific examples to easily explain the technical content of the present disclosure and to aid understanding of the present disclosure, and are not intended to limit the scope of the present disclosure. That is, it will be clearly understood by those skilled in the art that other modifications based on the technical idea of the present disclosure can be implemented. In addition, each of the embodiments described above can be operated in combination with each other as needed. For example, all embodiments of the present disclosure may be implemented by the system 100, the gemstone processing apparatus 110, the server 120 and/or the terminal 130, and the like in combination with each other.

In addition, the method of controlling the system 100, the gemstone processing apparatus 110, the server 120 and/or the terminal 130, and the like according to the present disclosure may be implemented in the form of program instructions that can be executed through various computer means and recorded in a computer-readable medium.

As described above, various embodiments of the present disclosure may be implemented as computer readable code in a computer readable recording medium from a specific viewpoint. The computer-readable recording medium is any data storage device that is capable of storing data that can be read by a computer system. Examples of the computer-readable recording medium may include a read only memory (ROM), a random access memory (RAM), and a compact disc-read only memory (CD-ROM), magnetic tapes, floppy discs, optical data storage devices, and carrier waves (such as data transmission over the Internet or the like). The computer readable recording medium may also be distributed through network-connected computer systems, so that the computer readable code is stored and executed in a distributed manner. In addition, functional programs, codes, and code segments for realizing various embodiments of the present disclosure can be easily interpreted by skilled programmers in the art to which the present disclosure is applied.

In addition, it will be appreciated that the user terminal and the method according to various embodiments of the present disclosure can be realized in the form of hardware, software, or a combination of hardware and software. Such software may be stored in a volatile or nonvolatile storage device including a storage device such as a ROM or the like regardless of whether or not it is erasable or rewritable, for example, or stored in a memory such as a RAM, a memory chip, a device or an integrated circuit, for example, or stored in a storage medium that can be read optically or magnetically and also read by a machine (e.g., a computer), such as a compact disc (CD), a DVD, a magnetic disc, a magnetic tape or the like, for example. It will be understood that the method according to various embodiments of the present disclosure may be implemented by a computer or portable terminal including a control unit (control modules 610, 710, and 810) and a memory, and such a memory is an example of the machine-readable storage medium suitable for storing program or programs including instructions for implementing the embodiments of the present disclosure.

Accordingly, the present disclosure includes programs including codes for implementing the devices or the methods described in the claims of the present disclosure, and a machine-readable (computer-readable, or the like) storage medium storing the programs. Further, such a program may be transferred electronically through any medium, such as a communication signal transmitted through a wired or wireless connection, and the present disclosure suitably includes equivalents thereto.

The embodiments of the present disclosure disclosed in the present disclosure and drawings are merely presented as specific examples to easily explain the technical content of the present disclosure and to aid understanding of the present disclosure, and are not intended to limit the scope of the present disclosure. In addition, the embodiments according to the present disclosure described above are merely exemplary, and it will be understood by those skilled in the art that various changes in form and details may be made therein without departing from the spirit and scope of the disclosure as defined by the appended claims. Accordingly, the true scope of the present disclosure should be determined by the technical idea of the appended claims.

What is claimed is:

1. A system for acquiring high-strength jewels by cutting a gemstone into 100-sided body, comprising a gemstone processing apparatus comprising a holding means for holding the gemstone based on information indicating a predetermined holding strength; and
a processing means for cutting the gemstone based on information indicating a predetermined cutting strength, wherein
the predetermined holding strength and the predetermined cutting strength are reset based on image information on the gemstone, which is acquired through a sensor module installed in the gemstone processing apparatus,
the gemstone includes at least one of diamond, cubic zirconia (CZ), emerald, sapphire, ruby, or moissanite,
the system further comprises a control module that acquires the image information on the gemstone from the sensor module and resets the predetermined holding strength and the predetermined cutting strength based on the image information on the gemstone,
the sensor module includes a plurality of cameras, the plurality of cameras are fixed to the gemstone processing apparatus to capture images of the gemstone from different angles,
the holding means further comprises an angle adjusting means for changing an angle or direction for holding the gemstone,
the processing means further comprises i) a cutting means for cutting the gemstone, the cutting means comprising at least one of a metal saw, a laser cutting head, or an oxygen cutting torch, ii) a distance measuring means for measuring a distance between the cutting means and the gemstone, and iii) a distance adjusting means for changing a position of the cutting means, and
the control module is configured to:
acquire the image information on the gemstone acquired through the plurality of cameras;
acquire object information corresponding to an outline of the gemstone by applying an object feature extraction algorithm based on at least one of a histogram of oriented gradient (HOG), a haar-like feature, a local binary pattern (LBP), or a features from accelerated segment test (FAST) to the image information;
extract a number of planes of the gemstone from the object information;
generate information indicating cutting strength and information indicating a holding direction based on the number of extracted planes;
control the cutting means based on the information indicating the cutting strength, while setting the gemstone processing apparatus in a first processing mode when the number of extracted planes is less than a first threshold value, setting the gemstone processing apparatus in a second processing mode when the number of extracted planes is equal to or greater than the first threshold value and less than the second threshold value, and setting the gemstone processing apparatus in a third processing mode when the number of extracted planes is equal to or greater than the predetermined second threshold value; and
control the angle adjustment means based on the information indicating the holding direction.
